(19) United States
(12) Patent Application Publication
(10) Pub. No.: US 2020/0087984 A1
(43) Pub. Date: Mar. 19, 2020

(54) ROOFTOP FALL PROTECTION SYSTEM

(71) Applicant: Arthur J. Wells, Jacksonville, FL (US)

(72) Inventor: Arthur J. Wells, Jacksonville, FL (US)

(21) Appl. No.: 16/131,997

(22) Filed: Sep. 14, 2018

(51) Int. Cl. E06C 7/18; E06C 1/38; E06C 1/34; E06C 7/46; E04H 12/20; E04H 15/42; E04H 15/54

(52) U.S. Cl. CPC E06C 7/18; E06C 1/38; E06C 1/34; E04H 15/54; E04H 12/20; E04H 15/42; E06C 7/46

(57) ABSTRACT

The present invention discloses a rooftop fall protection system including a plurality of mast assemblies and at least one ladder assembly removably engaged with the mast assembly. The ladder facilitates the elevation of a human to an elevated surface on a structure. Each of the ladder assemblies and mast assemblies are coupled to at least one cross-member positioned at a height above the perimeter of the elevated surface. The cross-member protects the human from falling from the elevated surface of the structure.

### TECHNICAL FIELD

The embodiments presented relate to fall protection systems attached to roofs of residential and commercial structures.

### BACKGROUND

Roofing can be a dangerous profession necessitating various safety regulations to be put into effect for the protection of the workers, bystanders, and the property itself. Because of the force and injuries sustained when a worker falls from any elevated position, such falls have accounted for up to ten percent of all workplace fatalities and an even greater number of nonfatal injuries. The Occupational Safety and Health Administration (OSHA) now requires the use of fall protection systems with specific minimum requirements for roofing work where the workers will be exposed to a fall of 6 feet or more. Some of the approved types of safety systems are defined as fall elimination, fall prevention, fall arrest, fall restraint, and administrative controls which are utilized when working at a height; however, they these systems can similarly be utilized when working near any edge or steep surface.

Various advances in fall protection devices have been proposed; however, many are non-universal, and far too complex for mass production or quick and proper installation. Such complex systems require a high amount of resources and training dedicated to their proper installation, making it a complex and time-consuming process which can delay jobs or leave additional opportunity for user error. Because these systems may not be adaptable to every job site, roofing companies would have to purchase and maintain several different types of fall protection devices in order to ensure a safe working environment at each unique site. Even when such systems are in place and have been properly installed, these systems have significant limitations that often require the worker to wear additional personal protection equipment during inclement weather conditions, meaning that at least two or more different fall protection systems would be required simultaneously.

Various types of fall protection systems currently exist in the art. Personal Fall Arrest Systems are one of the most common systems used and typically involve an anchor, harness, and cable wherein the worker must wear a harness that is attached by some form of cable to an anchor point. These systems attempt to catch a worker before they would make impact with the ground, but they rely on specific calculations of the distance to the ground to ensure the worker does not make impact. Further, because often times the roofs being worked on may be of a shape or variable height that would result in varying distances to the ground depending on where the worker fell from, the system may require that the worker's line be restricted to a distance short enough to mitigate a fall from certain portions of the roof and too short for the same worker to reach other parts of the roof while still connected to the same anchor. Consequently, these systems may either restrict the movements of the worker or leave room for fatal errors.

Another shortcoming in fall protection systems is the lack of ability to incorporate a climate protection system such as a cover, awning system, or roof-like device over the fall protection system. During inclement weather conditions, roofing work may prove too dangerous to perform, even with several existing safety systems in place. Inclement weather may also result in a secondary concern that is the ability to continue working on the project. Roofing often involves stripping away portions of the roof of a structure, leaving it vulnerable to the elements, especially rain. Often times, roofing jobs must be suspended during such conditions and the roof must be covered in water resistant materials such as tarps to protect the structure from water damage. This often results in costly delays and a decrease in work capacity. With high temperatures affecting workers abilities, as well as rain and wind affecting the ability and safety to perform roofing procedures, a climate protection system could save resources while increasing safety and productivity in the workplace.

### SUMMARY OF THE INVENTION

This summary is provided to introduce a variety of concepts in a simplified form that is further disclosed in the detailed description of the invention. This summary is not intended to identify key or essential inventive concepts of the claimed subject matter, nor is it intended for determining the scope of the claimed subject matter.

In one aspect, a rooftop fall protection system includes a plurality of mast assemblies and at least one ladder assembly. The ladder assembly is removably engaged with a mast assembly to facilitate the elevation of a human to an elevated surface of a structure. Each ladder assembly and mast assembly are removably engaged with at least one cross-member extending along the perimeter of the elevated surface at a height sufficient to prevent the human from falling from the elevated surface.

In another aspect, the ladder assembly is comprised of a main ladder, and one or more ladder extensions. At least one support assembly stabilized each ladder to a surface, such as the ground.

In another aspect, each mast assembly includes an extendable central portion separating a top portion and a base portion. The top portion of each of the plurality of mast assemblies is configured to releasably engage with a canopy, while the base portion is configured to anchor to a surface. In yet another aspect, the surface is an elevated surface defined by one or more angular planes. The base portion includes a folding base to conform to the one or most angular planes and provide stability to the mast assembly.

In yet another aspect, the rooftop fall protection system also includes adjustable length spreaders affixed between the structure and the ladder assembly to provide support to the central portion of the ladder. Fascia anchors and ladder roof support assemblies are affixed between the structure and each ladder to provide further even stability.

Moreover, in accordance with a preferred embodiment of the present invention, other aspects, advantages, and novel features of the present invention will become apparent from the following detailed description in conjunction with the drawings.

### BRIEF DESCRIPTION OF THE DRAWINGS

A more complete understanding of the present invention and the advantages and features thereof will be more readily understood by reference to the following detailed description when considered in conjunction with the accompanying drawings wherein:

FIG. 1 illustrates a fall protection system used on a structure, according to some embodiments;

FIG. 2 illustrates a fall protection system used on a structure having a cover, according to some embodiments;

FIG. 3 illustrates a perspective view of a support assembly of the fall protection system, according to some embodiments;

FIG. 4 illustrates a front elevation view of a ladder assembly of the fall protection system, according to some embodiments;

FIG. 5 illustrates a perspective view of a mast assembly of the fall protection system, according to some embodiments;

FIG. 6 illustrates a perspective view of a ladder clasp assembly, according to some embodiments;

FIG. 7 illustrates a perspective view of the ladder clasp assemblies, according to some embodiments;

FIG. 8 illustrates a perspective view of a corner connector to engage with the elevated surface, according to some embodiments;

FIG. 9 illustrates a perspective view of an extension connector, according to some embodiments;

FIG. 10 illustrates a perspective view of a spreader, according to some embodiments;

FIG. 11 illustrates a perspective view of a fascia anchor, according to some embodiments;

FIG. 12 illustrates a perspective view of a ladder coupling assembly to couple an end of the ladder assembly to the elevated surface, according to some embodiments;

FIG. 13 illustrates a perspective view of a ladder clasp, according to some embodiments; and

FIG. 14 illustrates a side elevation view of a spike, according to some embodiments.

### DETAILED DESCRIPTION

The specific details of the single embodiment or variety of embodiments described herein are to the described system and methods of use. Any specific details of the embodiments are used for demonstration purposes only and not unnecessary limitations or inferences are to be understood therefrom.

No single embodiment includes features that are necessarily included in all embodiments unless otherwise stated. Furthermore, although there may be references to “advantages” provided by some embodiments, other embodiments may not include those same advantages or may include different advantages. Any advantages described herein are not to be construed as limiting to any of the claims.

Before describing in detail exemplary embodiments, it is noted that the embodiments reside primarily in combinations of components related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

As used herein, relational terms, such as “first” and “second” and the like, may be used solely to distinguish one entity or element from another entity or element without necessarily requiring or implying any physical or logical relationship or order between such entities or elements.

In general, the embodiments described present a fall protection system used by roofers or other laborers working at an elevation, near an edge, or on a steep surface. The system is provided as a means for fall prevention and fall arrest, such that laborers are both prevented from falling well as stopped if they are in the act of falling from an elevated surface. The system can be utilized as a temporary means for fall protection while being suitable for long-term use if a continued need for fall prevention is required. Components of the system 100 can be formed of any suitable material, although for strength, the components may be formed of forged steel, hardened steel, stainless steel, carbon, alloy and the like. The system 100 will not substantially interfere with the installation of exterior wall sheathing, siding, etc. All components can be conveniently removed when the fall prevention system 100 is no longer needed, usually after roofing has been installed. It is possible to separate the system 100 into a plurality of segments which can be defined as a ladder assembly 116 affixed to a mast assembly 112, a single mast assembly 112 and the cross-members 128 extending therebetween. If necessary, one or more segments can be detached to allow entrance or movement of framing or roofing materials, followed by quick and easy deployment of those sections for safety.

As used herein, the term “structure” can include a commercial or residential building, house, complex, etc. The term “elevated surface” can be any roof configuration known in the roofing arts, rafters, or other elevated surfaces common to the construction and roofing industries.

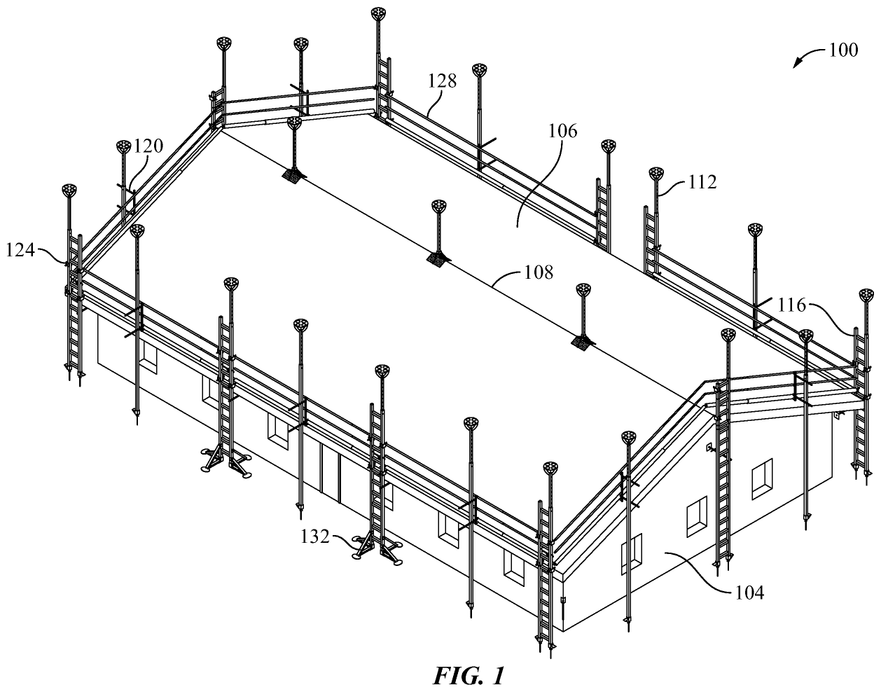

In reference to FIG. 1, the rooftop fall protection system 100 is shown. The system 100 can he engaged with a structure 104 to prevent a human from falling from an elevated surface 106. The system 100 is modular to accommodate various elevated surface heights and pitches and can be used with any configuration of roof including open gable, box gable, dormer, hip, gambrel, butterfly, flat, shed, pyramid hip, etc. The system 100 includes mast assemblies 112 are positioned around the perimeter of the elevated surface 106 and secured to the ground or to a sufficiently secure lower surface. A ladder 116 can be removably engaged to one or more of the mast assemblies 112 via a plurality of retainers 124. The ladder 116 is removably engaged to provide sufficiently rigid connection to the mast assembly 112 to permit a human to climb up and down the ladder 116. A plurality of cross-members 128 extend between each mast assembly 112 and ladder 116 positioned about the perimeter of the structure 104 such that the cross-members 128 form a guard-rail to prevent roofers from falling from the elevated surface. Support members 120 affix the mast assembly 112 to the cross-members 128 to ensure a sufficiently rigid connection to stop a falling human.

In reference to FIG. 2, the fall protection system 100 includes a canopy 200 to cover the elevated surface 106 of the structure sufficiently. In some embodiments, the canopy 200 can be constructed from waterproof materials to protect the elevated surface during periods of inclement weather when work must be delayed. The canopy 200 can be releasably engaged at height h₃, which is defined as the height of the top portion 503 (see FIG. 5) of the mast assemblies 112. The distance between h₂ and h₃ is preferably high enough to permit standing and working operations of the workers on the elevated surface 106.

The canopy 200 can be constructed of a flexible material such as a tarp made of canvas, polyethylene, or polyester which can optionally be coated with polyurethane. Alternatively, it is contemplated the canopy 200 can be a rigid material such as metal, wood, hard plastic, or similar material which can affix to the top portion 503 of the mast assemblies 112.

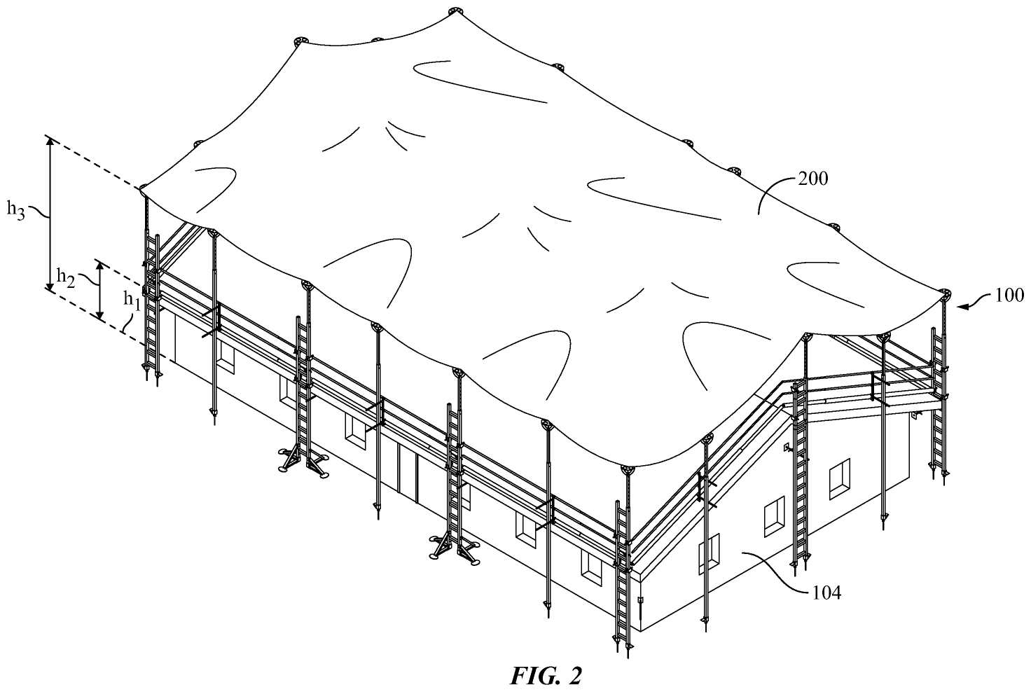

FIG. 3 illustrates a support member 132 configured to provide a sufficiently stable base for a ladder assembly 116 to rest on the ground surface (at height h₁). First and second base portions 301, 303 extend outward from lateral arms 307, 309 which are each affixed to central portion 305. The central portion 305 includes an aperture to receive a vertical member of the ladder assembly 116. Secondary member 311 extends from the first base portion 301 to a first bracket 313, while the tertiary member 315 extends from the second base portion 303 to a second bracket 317. Central portion 305, first bracket 313, and second bracket 317 each engage with the vertical member of the ladder assembly 116. In some embodiments, a support member 132 can be positioned on each vertical member of the ladder assembly 116, such that there are two support members per ladder assembly 116 during use. The first and second brackets 313 317 can releasably engage the vertical members using fasteners to ensure the ladder assembly 116 does not fall out of contact with the brackets and compromise stability of the support member 132. In a preferred embodiment, the bottom side of the first and second base portions 301, 303 can be padded to increase friction and prevent sliding of the support member 132 and protect the ground surface from being damaged during use.

In some embodiments, the lateral arms 307,309 and the second and tertiary members 311,315 can pivot to provide a sufficiently stable base on an uneven ground surface.

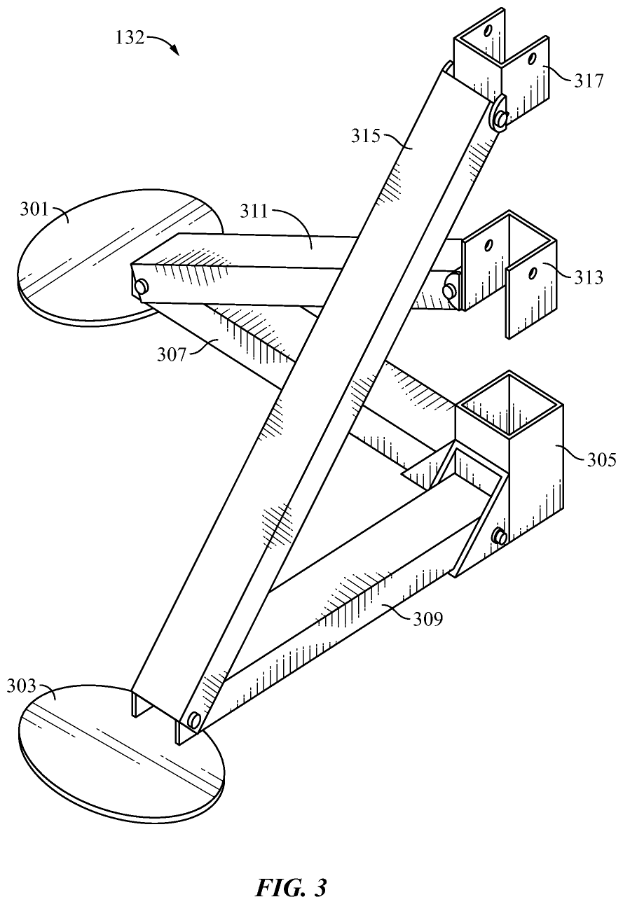

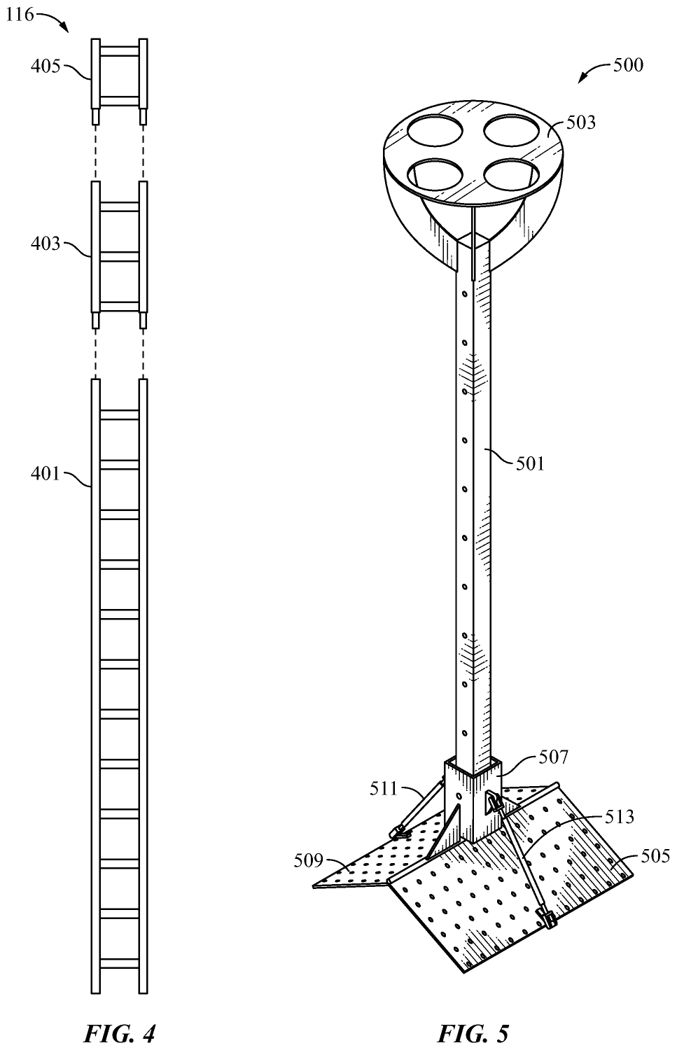

Now referring to FIG. 4, the ladder assembly 116 is illustrated. The ladder 401 can be constructed of any sufficiently rigid material to permit a human to climb up and down using the rungs. The assembly 116 can be extendable by engaging any number of extensions 403, 405 to an end of the ladder 401. The illustrated embodiment shows a first extension 403 and a second extension 405 of varying lengths. It is understood that any length of extension can be used. In an alternate embodiment, an extendable or telescoping ladder having two or more sliding members to extend the overall length of the ladder assembly 116 can be utilized.

FIG. 5 illustrates an alternate embodiment of a canopy mast assembly 500. The canopy mast assembly 500 shares the central portion 501 and top portion 503 of the mast assembly 112, but differs in the base portion 507. In a preferred embodiment, the base portion 507 includes an aperture to receive the central portion 501 to maintain the stability of the central portion 501 by prohibiting movement or rotation thereof. Folding bases 505, 509 fold to accommodate the slope of the elevated surface and are supported by extendable members 511, 513. The folding bases 505, 509 can be affixed to the apex 108 of the elevated surface while the canopy 200 is affixed to the top portion 503. Similarly, the mast assemblies 112 can include a spike 1400 (see FIG. 14) positioned at the bottom of the central portion 501 to anchor the mast assembly 112 to the ground surface.

In some embodiments, the central portion 501 can extend by telescoping members nested within its interior cavity.

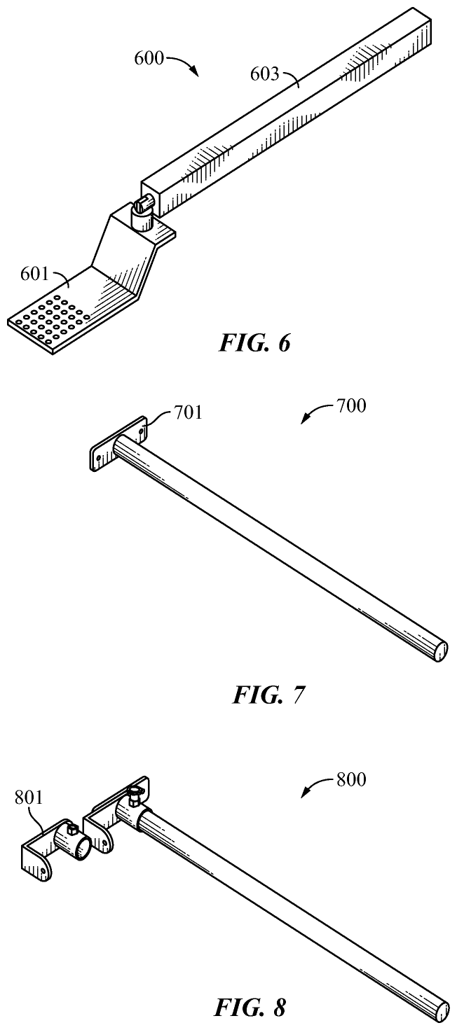

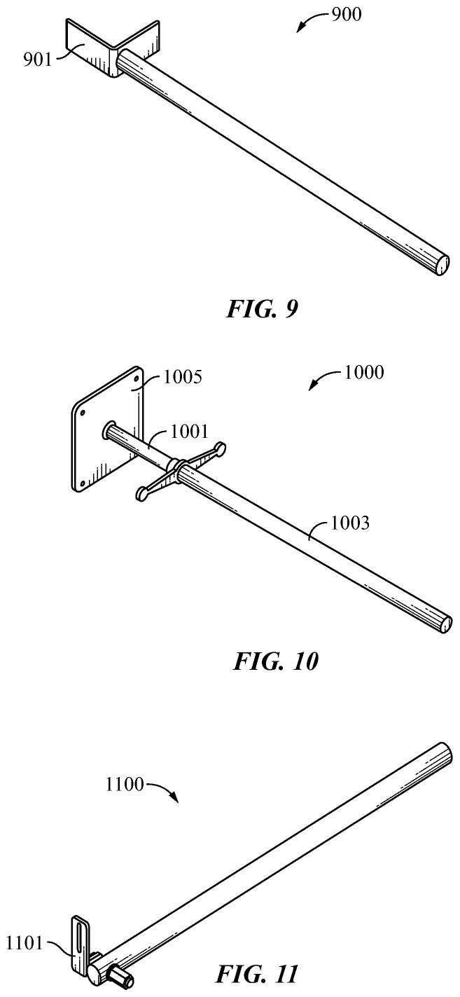

FIGS. 6-9 illustrate ladder support devices to secure the ladder assembly 116 to various surfaces and components of the system 100. A ladder clasp 600 includes a connection means 601 which fastens to a surface, and an extension 603 extending therefrom. A connector 700 includes fastening portion 701 which can anchor to the elevated surface 106. FIG. 8 shows a corner connector 800 where a mount 801 permits the corner connector 800 to engage with a vertical member of a ladder 401 and permit the cross-members 128 to extend an any angle therefrom. Similarly, FIG. 9 illustrates an extension connector 900 which has a securing portion 901 which is affixed to a ladder 401 or central portion 501 of a mast assembly 112. The cross-members 128 extend parallel to the adjacent cross-members 128.

FIG. 10 illustrates a spreader 1000 including a threaded portion 1001 positioned between a brace 1003, and a brace anchor 1005 mounted to the sidewall of the structure 104. The spreader 1000 functions to support the middle region of the ladder assembly 116 which can become bent or misaligned during use. The threaded portion 1001 allows the spreader to extend between the sidewall of the structure 104 and the ladder assembly 116 which is affixed to the end of the brace 1003. Rotating the threaded portion in relation to the brace 103 extends the overall length of the spreader to adapt to changes in the distance between the ladder assembly 116 and the sidewall of the structure 104.

FIG. 11 shows a fascia anchor 1100 having a connection portion 1101 which affix to a bracket anchored to the fascia board of the structure.

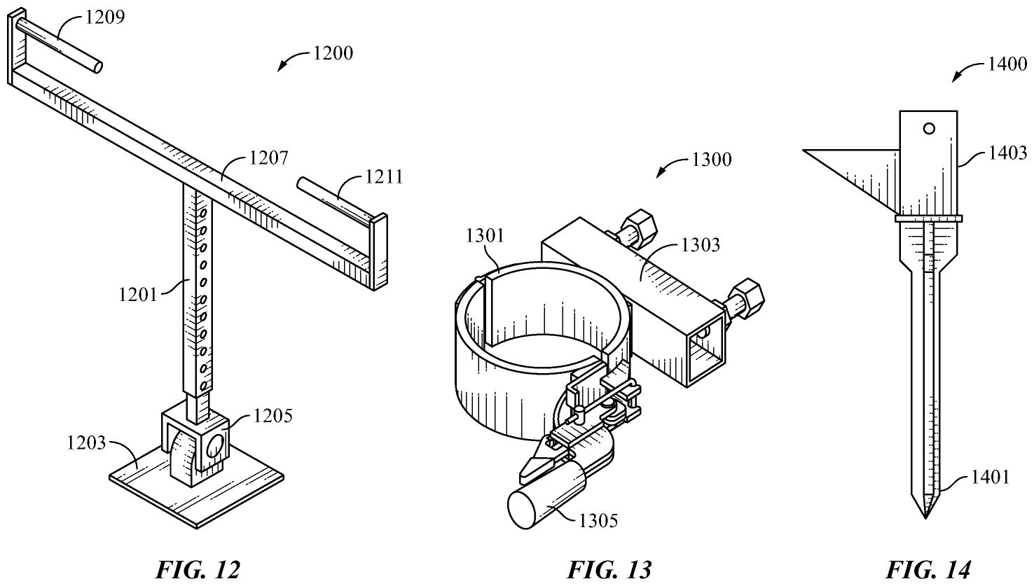

FIG. 12 shows a ladder coupling assembly 1200 having a central component 1201 extending between a roof anchor 1203 and a beam 1207. The roof anchor pivots via hinge mechanism 1205 to adapt to various pitches of the elevated surface 106. The beam 1207 is dimensioned to permit locking components 1209, 1211 to engage with the outer surface of the ladder 401 to secure the top of the ladder assembly 116 to the elevated surface.

FIG. 13 illustrates a ladder clasp 1300 having a loop 1301 which is dimensioned to frictionally engage with the ladder assembly 116. Portion 1303 includes one or more fasteners to fasten the clasped ladder assembly 116 to a surface on the structure, while a locking mechanism 1305 tightens the loop 1301 to impart friction to the ladder assembly 116.

FIG. 14 shows a spike 1400 which penetrate the ground surface to anchor the mast assemblies 112 and ladder assemblies 116 thereto. Each spike 1400 includes an attachment means 1403, such as a bracket, to affix the spike to the bottom end of the mast assemblies 112 and ladder assemblies.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

1. A fall protection system comprising:
a plurality of mast assemblies;
at least one ladder assembly removably engaged with the at a mast assembly, the ladder assembly facilitating the elevation of a human to an elevated surface of a structure; and
at least one cross-member positioned at a height above the perimeter edge of the elevated surface, the at least one ladder assembly and the at least one mast assembly removably engaged with the at least one cross-member to protect the human from falling from the elevated surface.

2. The system of claim 1, wherein the ladder assembly is comprised of a main ladder, and one or more ladder extensions.

3. The system of claim 1, further comprising at least one support assembly stabilizing each ladder to a surface.

4. The system of claim 1, wherein each mast assembly includes an extendable central portion separating a top portion and a base portion.

5. The system of claim 4, wherein the top portion of each of the plurality of mast assemblies is configured to releasably engage with a canopy that covers at least a portion of the elevated surface of the structure, the mast assemblies configured to hold the canopy above the structure at a sufficient height to enable a human to work under the canopy above the elevated surface of the structure.

6. The system of claim 4, wherein the base portion is configured to anchor to a surface.

7. The system of claim 1, wherein the elevated surface is defined by at least two planes forming an apex.

8. The system of claim 7, wherein at least one of the plurality of mast assemblies includes a base portion configured to conform to the apex formed by the at least two planes.

9. A fall protection system comprising:
a plurality of mast assemblies each including a top portion configured to releasably engage a canopy and a bottom portion anchored to a surface;
at least one ladder assembly removably engaged with at least one of the plurality of mast assemblies, the ladder assembly facilitating the elevation of a human to an elevated surface of a structure; and
at least one cross-member positioned along the perimeter edge of the elevated surface, at least one ladder assembly and at least one mast assembly removably engaged with the at least one cross-member to protect the human from falling from the elevated surface.

10. The system of claim 9, wherein the ladder assembly is comprised of a main ladder, and one or more ladder extensions.

11. The system of claim 10, further comprising:
at least one adjustable length spreader affixed between the structure and the ladder assembly;
at least one fascia anchor affixed between the structure and the ladder; and
at least one ladder roof support assembly anchoring the ladder assembly to the elevated surface.

12. The system of claim 9, further comprising at least one support assembly stabilizing each ladder with the surface.

13. The system of claim 12, wherein the support assembly includes two or more brackets configured to couple with the ladder assembly.

14. The system of claim 9, wherein each mast assembly includes an extendable central portion separating the top portion and the base portion.

15. The system of claim 9, wherein the elevated surface is defined by planes forming an apex.

16. The system of claim 15, wherein the base portion includes a folding base to conform to the apex.

17. The system of claim 9, further comprising a plurality of spikes, wherein each spike anchors one of the ladder assemblies, or one of the mast assemblies to the surface.

18. The system of claim 9, wherein the canopy is constructed of a waterproof material.

19. A fall protection system comprising:
a plurality of mast assemblies each including a top portion configured to releasably engage a canopy and a bottom portion anchored to a surface;
at least one ladder assembly removably engaged with a mast assembly, a ladder assembly facilitating the elevation of a human to an elevated surface of a structure, wherein the ladder assembly is secured to the surface by at least one support assembly, and wherein the ladder assembly is secured to the structure by at least one fascia anchor affixed between the structure and the ladder assembly, and at least one ladder roof support assembly affixed between the elevated surface and the ladder assembly; and
at least one cross-member positioned along the perimeter edge of the elevated surface, a ladder assembly and a mast assembly removably engaged with the at least one cross-member to protect the human from falling from the elevated surface.

20. (canceled)

21. The system of claim 19, wherein the mast assemblies are configured to hold the canopy above the structure at a sufficient height to enable a human to work under the canopy above the elevated surface of the structure.
